(19) United States
(12) Patent Application Publication
(10) Pub. No.: US 2013/0115435 A1
(43) Pub. Date: May 9, 2013

(54) LAMINATED WINDSHIELD GLASS

(71) Applicants: Thomas D. Hagen, Grand Blanc, MI (US); Gary L. Walters, Ortonville, MI (US)

(72) Inventors: Thomas D. Hagen, Grand Blanc, MI (US); Gary L. Walters, Ortonville, MI (US)

(73) Assignee: GM GLOBAL TECHNOLOGY OPERATIONS LLC, Detroit, MI (US)

(21) Appl. No.: 13/289,037

(22) Filed: Nov. 4, 2011

(51) Int. Cl. B32B 7/02; B32B 3/00; B32B 17/10

(52) U.S. Cl. 428/213; 428/441; 428/332

(57) ABSTRACT

A laminated glass assembly includes an annealed outer glass panel and an inner glass panel. A first Polyvinyl Butyral (PVB) layer is disposed adjacent the outer glass panel, and a second PVB layer is disposed adjacent the inner glass panel. A polymeric film layer of Polyethylene Terephthalate (PET) is disposed between the first PVB layer and the second PVB layer. The outer glass panel, the first PVB layer, the polymeric film layer, the second PVB layer and the inner glass panel are bonded together to form the laminated glass assembly. The polymeric film layer may include a deformation control mechanism, such as scoring, cuts or perforations disposed therein, to alter a mechanical elongation characteristic of the polymeric film layer.

### TECHNICAL FIELD

The invention generally relates to a laminate glass assembly, and more specifically to a laminated glass windshield for a vehicle.

### BACKGROUND

Typical laminated windshield assemblies are constructed from an outer layer of annealed glass, a Polyvinyl Butyral (PVB) layer, and an inner layer of glass. When an object strikes the windshield assembly with sufficient energy, the outer and inner glass panels break, and with continued energy input, the windshield assembly will deform based upon the mechanical elongation properties of the PVB layer sandwiched between the inner and outer glass panels. Elongation of the PVB layer absorbs at least a portion of the impact energy after the inner and outer glass panels break. The energy absorption profile of the laminated windshield assembly is dependent upon the elongation of the PVB layer at each fracture location, and the adhesion of the PVB layer to the inner and outer glass layers constraining elongation.

### SUMMARY

A laminated glass assembly is provided. The laminated glass assembly includes an outer glass panel and an inner glass panel. The outer glass panel defines an exterior surface and an opposing first laminate surface. The inner glass panel defines an interior surface and an opposing second laminate surface. A first Polyvinyl Butyral (PVB) layer is disposed adjacent the first laminate surface. A second PVB layer is disposed adjacent the second laminate surface. A polymeric film layer is disposed between the first PVB layer and the second PVB layer.

A laminated glass windshield for a vehicle is also provided. The laminated glass windshield includes an outer glass panel and an inner glass panel. The outer glass panel defines an exterior surface and an opposing first laminate surface. The outer glass panel includes annealed glass. The inner glass panel defines an interior surface and an opposing second laminate surface. A first Polyvinyl Butyral (PVB) layer is disposed adjacent the first laminate surface. A second PVB layer is disposed adjacent the second laminate surface. A polymeric film layer of Polyethylene Terephthalate (PET) is disposed between the first PVB layer and the second PVB layer. The polymeric film layer includes a deformation control mechanism. The deformation control mechanism alters an elongation characteristic of the polymeric film layer in response to a transverse impact load applied to one of the outer glass panel or the inner glass panel.

Accordingly, the laminated glass assembly, and specifically the polymeric film layer disposed between the first PVB layer and the second PVB layer, deforms at a controlled rate over time, absorbing energy during displacement thereof. The deformation control mechanism, including but not limited to serrations, cuts, scores, or some other configuration of void defined by the polymeric film layer, controls the rate or amount of elongation of the polymeric film layer. By reducing a thickness of the inner glass panel and/or the outer glass panel compared to standard windshield assemblies, in combination with the energy absorption provided by the laminated PVB layer (the combination of the first PVB layer and the second PVB layer with the polymeric film layer disposed therebetween), the laminated windshield assembly disclosed herein reduces the load at which the inner glass panel and the second glass panel break and absorbs impact energy during deformation, thereby improving pedestrian protection.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross sectional view of a laminated glass assembly.

FIG. 2 is a schematic exploded cross sectional view of the laminated glass assembly.

FIG. 3 is a schematic plan view of a polymeric film layer of the laminated glass assembly showing a deformation control mechanism.

### DETAILED DESCRIPTION

Those having ordinary skill in the art will recognize that terms such as “above,” “below,” “upward,” “downward,” “inner,” “outer,” etc., are used descriptively for the figures, and do not represent limitations on the scope of the invention, as defined by the appended claims.

Referring to the Figures, wherein like numerals indicate like parts throughout the several views, a laminated glass assembly is generally shown at 20. The laminated glass assembly 20 may be used, for example, as a laminated glass windshield for a vehicle. However, it should be appreciated that the laminated glass assembly 20 is not limited to use as a windshield, and may be used for other applications.

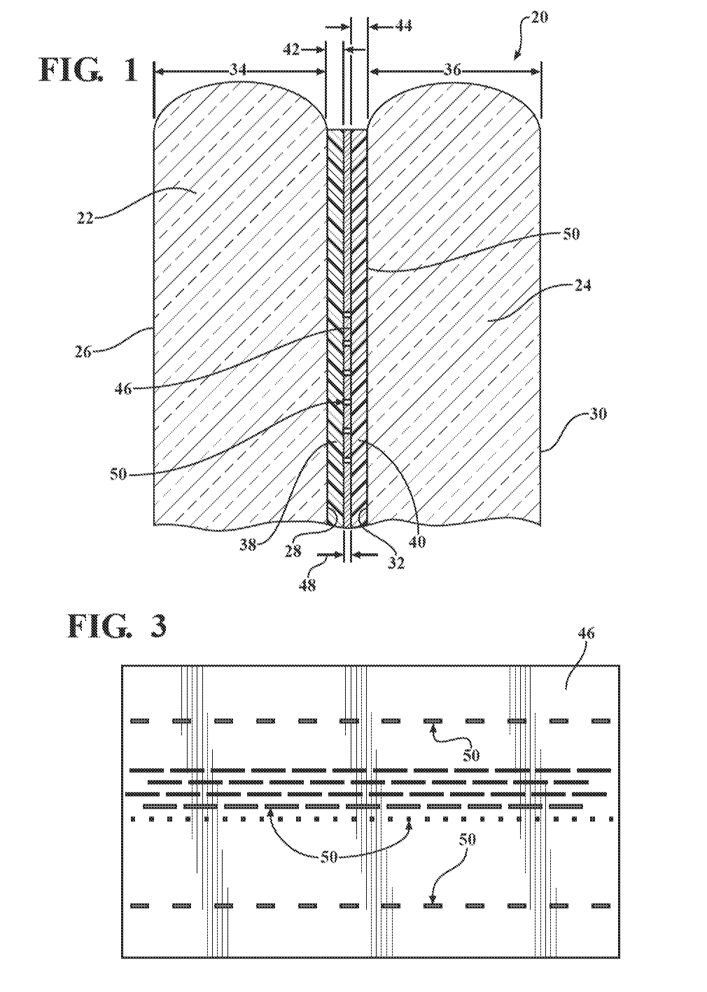

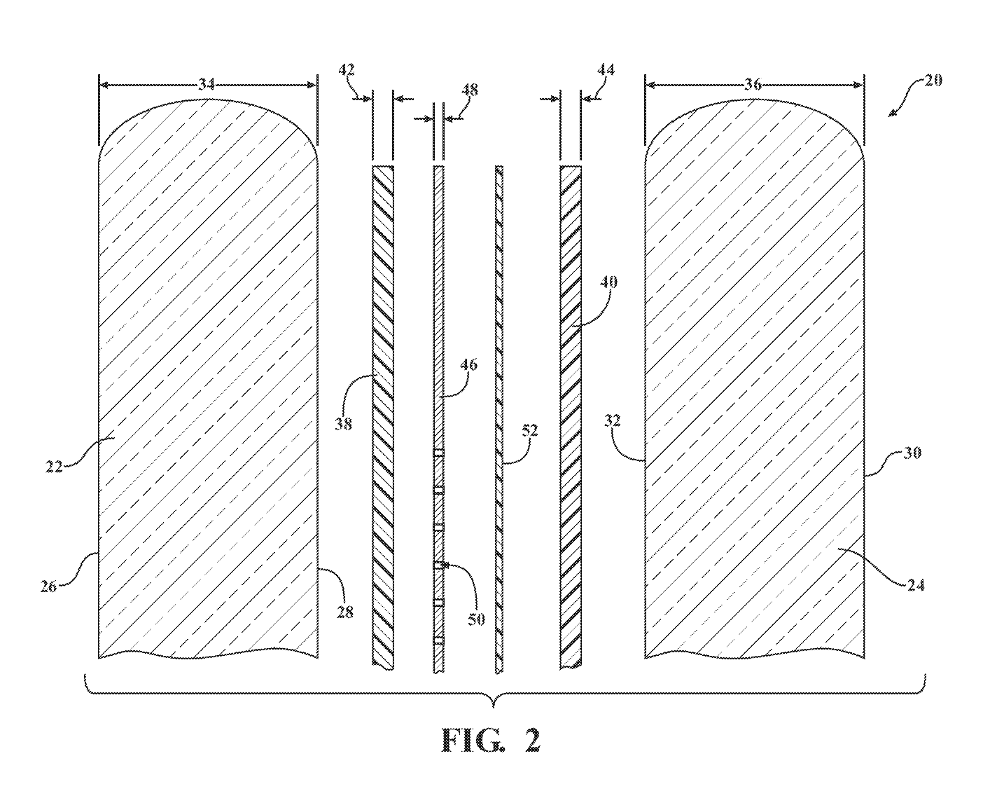

Referring to FIGS. 1 and 2, the laminated glass assembly 20 includes an outer glass panel 22 and an inner glass panel 24. The outer glass panel 22 defines an exterior surface 26 and an opposing first laminate surface 28. The inner glass panel 24 defines an interior surface 30 and an opposing second laminate surface 32. The first laminate surface 28 of the outer glass panel 22 is disposed opposite, i.e., faces, the second laminate surface 32 of the inner glass panel 24. The outer glass panel 22 may include, but is not limited to, an annealed glass panel or a heat strengthened glass panel suitable for exposure to the elements and/or airborne objects, or other use specific considerations. As shown in FIG. 2, the outer glass panel 22 includes a thickness 34 between the range of 1.60 mm and 2.60 mm. Similarly, the inner glass panel 24 includes a thickness 36 between the range of 1.60 mm and 2.60 mm. The thickness 34 of the outer glass panel 22 may be identical to the thickness 36 of the inner glass panel 24. Alternatively the thickness 34 of the outer glass panel 22 may be different from the thickness 36 of the inner glass panel 24. Each of the outer glass panel 22 and the inner glass panel 24 may include a thickness between the range of 1.6 mm and 2.6 mm, with a total thickness of the laminated glass assembly 20 between the range of 4.0 mm and 6.0 mm. Because the outer glass panel 22 and the inner glass panel 24 are thinner than the glass panes of prior art laminated windshields, the laminated glass assembly 20 requires a smaller impact load, i.e., less energy, to break the outer glass panel 22 and the inner glass panel 24, thereby reducing possible injury to a pedestrian in the event of a pedestrian impact with the laminated glass assembly 20. Additionally, the thickness 34 of the outer glass panel 22 and the thickness 36 of the inner glass panel 24 may be customized to control the amount of energy required to break the outer glass panel 22 and/or the inner glass panel 24.

The laminated glass assembly 20 further includes a first Polyvinyl Butyral (PVB) layer 38 and a second PVB layer 40. The first PVB layer 38 is disposed adjacent the first laminate surface 28 of the outer glass panel 22. The second PVB layer 40 is disposed adjacent the second laminate surface 32 of the inner glass panel 24. The first PVB layer 38 and the second PVB layer 40 may be attached or otherwise bonded to the outer glass panel 22 and the inner glass panel 24 in any suitable manner, including but not limited to adhesively bonding the first PVB layer 38 and/or the second PVB layer 40 to the outer glass panel 22 and the inner glass panel 24 respectively during a lamination process. The lamination process may include heating the laminated glass assembly 20 under pressure in an autoclave. As shown in FIG. 2, the first PVB layer 38 includes a thickness 42 between the range of 0.30 mm and 0.80 mm. Preferably, the thickness 42 of the first PVB layer 38 is equal to 0.38 mm. Similarly, the second PVB layer 40 includes a thickness 44 between the range of 0.30 mm and 0.80 mm. Preferably, the thickness 44 of the second PVB layer 40 is equal to 0.38 mm. The thickness 42 of the first PVB layer 38 may be identical to the thickness 44 of the second PVB layer 40. Alternatively the thickness 42 of the first PVB layer 38 may differ from the thickness 44 of the second PVB layer 40. While the first PVB layer 38 and the second PVB layer 40 are described herein as including Polyvinyl Butyral, it should be appreciated that the first PVB layer 38 and the second PVB layer 40 may include and/or be manufactured from some other material not described herein.

The laminated glass assembly 20 further includes a polymeric film layer 46. The polymeric film layer 46 is disposed between and attached to the first PVB layer 38 and the second PVB layer 40. The polymeric film layer 46 is used as a constraining material between the first PVB layer 38 and the second PVB layer 40 to control the elongation of the laminated glass assembly 20 during an impact event. The polymeric film layer 46 may be attached or otherwise bonded to the first PVB layer 38 and the second PVB layer 40 in any suitable manner, including but not limited to adhesively bonding the polymeric film layer 46 to the first PVB layer 38 and/or the second PVB layer 40 respectively during the lamination process. As described above, the lamination process may include heating the laminated glass assembly 20 under pressure in an autoclave. The polymeric film layer 46 may include but is not limited to Polyethylene Terephthalate (PET). Alternatively, the polymeric film layer 46 may include any material having a maximum elongation of approximately 100% of its original length, having good puncture/tear resistance, a resistance to high temperatures without becoming brittle, and is highly transparent. As shown in FIG. 2, the polymeric film layer 46 includes a thickness 48 between the range of 0.10 mm and 0.30 mm. Preferably, the thickness 48 of the polymeric film layer 46 is equal to 0.18 mm.

Referring also to FIG. 3, the polymeric film layer 46 may include a deformation control mechanism 50. The deformation control mechanism 50 alters an elongation characteristic of the polymeric film layer 46. The deformation control mechanism 50 may be included in the laminated glass assembly 20 to control the rate of elongation in response to a transverse impact load applied to one of the outer glass panel 22 or the inner glass panel 24. Accordingly, the deformation control mechanism 50 may be included in the laminated glass assembly 20 to alter and or control an energy absorption rate of the laminated glass assembly 20 over time as the laminated glass assembly 20 expands. The deformation control mechanism 50 may include, but is not limited to, one of scoring of the polymeric film layer 46, perforations formed into the polymeric film layer 46, cuts formed into the polymeric film layer 46, or some other form of void, crease or weakness formed into and/or defined by the polymeric film layer 46. The deformation control mechanism 50 operates to weaken the polymeric film layer 46 against elongation, thereby altering the rate of elongation, i.e., increasing the rate or speed at which the polymeric film layer 46 elongates, and lowering the energy required to elongate the laminated glass assembly 20, thereby reducing the potential for possible injury to a pedestrian in the event of a pedestrian impact. It should be appreciated that the orientation and/or direction of the deformation control mechanism 50, e.g., the direction of the perforations in the polymeric film layer 46, control and/or affect the elongation of the polymeric film layer 46. Accordingly, the orientation and/or configuration of the deformation control mechanism 50 may control the elongation of the polymeric film layer 46 to allow for different elongation rates in different directions by orientating the deformation control mechanism 50 in a particular manner.

The laminated glass assembly 20 may further include a coating 52. The coating 52 may be applied to and disposed on a surface of the polymeric film layer 46. The coating 52 may be disposed adjacent one or both of the first PVB layer 38 or the second PVB layer 40. The coating 52 may include but is not limited to one of an infrared reflective coating 52 (to reflect solar energy), or an electrically conductive coating 52 (such as used for an antenna or a windshield heating function).

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A laminated glass assembly comprising:
an outer glass panel defining an exterior surface and an opposing first laminate surface;
an inner glass panel defining an interior surface and an opposing second laminate surface;
a first Polyvinyl Butyral (PVB) layer disposed adjacent the first laminate surface;
a second PVB layer disposed adjacent the second laminate surface; and
a polymeric film layer disposed between the first PVB layer and the second PVB layer.

2. A laminated glass assembly as set forth in claim 1 wherein the polymeric film layer includes Polyethylene Terephthalate (PET).

3. A laminated glass assembly as set forth in claim 1 wherein the polymeric film layer includes a deformation control mechanism configured for altering an elongation characteristic of the polymeric film layer in response to a transverse impact load applied to one of the outer glass panel or the inner glass panel.

4. A laminated glass assembly as set forth in claim 3 wherein the deformation control mechanism includes one of scoring of the polymeric film layer, perforations formed into the polymeric film layer, or cuts formed into the polymeric film layer.

5. A laminated glass assembly as set forth in claim 1 wherein the outer glass panel includes a thickness between the range of 1.60 mm and 2.60 mm.

6. A laminated glass assembly as set forth in claim 5 wherein the inner glass panel includes a thickness between the range of 1.60 mm and 2.60 mm.

7. A laminated glass assembly as set forth in claim 6 wherein the first PVB layer includes a thickness between the range of 0.30 mm and 0.80 mm.

8. A laminated glass assembly as set forth in claim 7 wherein the thickness of the first PVB layer is equal to 0.38 mm.

9. A laminated glass assembly as set forth in claim 7 wherein the second PVB layer includes a thickness between the range of 0.30 mm and 0.80 mm.

10. A laminated glass assembly as set forth in claim 9 wherein the thickness of the second PVB layer is equal to 0.38 mm.

11. A laminated glass assembly as set forth in claim 9 wherein the polymeric film layer includes a thickness between the range of 0.10 mm and 0.30 mm.

12. A laminated glass assembly as set forth in claim 11 wherein the thickness of the polymeric film layer is equal to 0.18 mm.

13. A laminated glass assembly as set forth in claim 1 further comprising a coating disposed on a surface of the polymeric film layer adjacent one of the first PVB layer and the second PVB layer.

14. A laminated glass assembly as set forth in claim 13 wherein the coating includes one of an infrared reflective coating or an electrically conductive coating.

15. A laminated glass assembly as set forth in claim 1 wherein the outer glass panel includes an annealed glass panel.

16. A laminated glass windshield for a vehicle, the laminated glass windshield comprising:
an outer glass panel defining an exterior surface and an opposing first laminate surface, wherein the outer glass panel includes annealed glass;
an inner glass panel defining an interior surface and an opposing second laminate surface;
a first Polyvinyl Butyral (PVB) layer disposed adjacent the first laminate surface;
a second PVB layer disposed adjacent the second laminate surface; and
a polymeric film layer of Polyethylene Terephthalate (PET) disposed between the first PVB layer and the second PVB layer;
wherein the polymeric film layer includes a deformation control mechanism configured for altering an elongation characteristic of the polymeric film layer in response to a transverse impact load applied to one of the outer glass panel or the inner glass panel.

17. A laminated glass windshield as set forth in claim 16 wherein:
the outer glass panel and the inner glass panel each include a thickness between the range of 1.60 mm and 2.60 mm;
the first PVB layer and the second PVB layer each include a thickness between the range of 0.30 mm and 0.80 mm; and
the polymeric film layer includes a thickness between the range of 0.10 mm and 0.30 mm.

18. A laminated glass windshield as set forth in claim 17 wherein the deformation control mechanism includes one of scoring of the polymeric film layer, perforations formed into the polymeric film layer, or cuts formed into the polymeric film layer.

19. A laminated glass windshield as set forth in claim 18 further comprising a coating disposed on a surface of the polymeric film layer adjacent one of the first PVB layer and the second PVB layer, wherein the coating includes one of an infrared reflective coating or an electrically conductive coating.
